(19) United States
(12) Patent Application Publication
(10) Pub. No.: US 2019/0139079 A1
(43) Pub. Date: May 9, 2019

(54) AUTONOMOUS MARKETING CAMPAIGN OPTIMIZATION FOR TARGETING AND PLACEMENT OF DIGITAL ADVERTISEMENTS

(71) Applicant: STEP ONE ANALYTICS CORP, San Francisco, CA (US)

(72) Inventor: Colette Nataf, San Francisco, CA (US)

(21) Appl. No.: 16/183,569

(22) Filed: Nov. 7, 2018

Related U.S. Application Data
(60) Provisional application No. 62/583,947, filed on Nov. 9, 2017.

(51) Int. Cl. G06Q 30/02

(52) U.S. Cl. CPC G06Q 30/0243; G06Q 30/0254; G06Q 30/0275

(57) ABSTRACT

Systems and methods for providing an artificial intelligence (AI) marketing campaign optimization platform or system that automates and optimizes bidding, audience matching, and retargeting of marketing campaigns to meet business goals on digital platforms. The campaign optimization system may autonomously plan and manage advertising campaigns for a plurality of organizations on one or more digital platforms. The campaign optimization system may provide autonomous bidding, autonomous audience matching, and autonomous creative optimization. The autonomous bidding features allow an organization (e.g., company) to target their highest value customers to reach their growth targets or other goals. A bidding automation tool optimizes every dollar spent on advertisements placed on digital platforms to ensure organizations are paying the optimum price for the optimum audience. An audience matching tool autonomously reveals new interest and audience groups, and identifies new keyword groups.

### BACKGROUND

### Technical Field

The present disclosure generally relates to computer-implemented systems, methods and articles that autonomously optimize marketing campaigns.

### Description of the Related Art

Online advertising is a form of marketing and advertising that uses the Internet or other network to deliver promotional marketing messages to consumers. Online advertising may include email marketing, search engine marketing, social media marketing, display advertising (e.g., web banner advertising), mobile advertising, among others. Online advertising may involve both a publisher, who integrates advertisements into its online content, and an advertiser, who provides the advertisements to be presented with the publisher's content. Other participants may include advertising agencies that help generate and place the advertisement copy, an advertisement server (“ad server”) which delivers the advertisements and tracks statistics, and advertising affiliates who do independent promotional work for the advertiser.

Generally, an ad server is a Web server that stores advertising content used in online marketing and delivers that content onto various digital platforms, such as Web sites, social media outlets, mobile applications, etc. Ad serving technology companies provide software or interfaces to publishers and advertisers to serve ads, count ads, select ads that make the publisher or advertiser the most money, monitor the progress of marketing campaigns, etc. Besides delivering ads to users, ad servers may manage the advertising space of a digital platform and may provide a counting and tracking system for advertisers/marketers. Ad servers may also act as a system in which advertisers can count clicks, impressions, or other actions to generate reports, which helps to determine the return on investment for particular advertisements.

Ad servers may traffic ads according to different business rules, and may target ads to different users or content. Ad servers may track impressions, clicks, or other post-impression, post-click or interaction metrics. Advertisers may use this data in running a marketing campaign in an attempt to place advertisement content on particular channels and to target particular groups of individuals where the advertisements will be most effective.

Online marketing platforms utilize a wide range of payment calculation methods for marketing campaigns. Non-limiting examples of such methods include cost per mille (CPM), cost per click (CPC), cost per install (CPI), and cost per action (CPA). CPM means that advertisers pay for every thousand displays or “impressions” of their advertisement to consumers. CPC means that advertisers pay each time a user clicks on or otherwise selects the advertisement. CPI, which is specific to mobile applications, means that advertisers pay each time an application is installed. CPA or pay per performance (PPP) means that the advertiser pays for the number of users who perform a desired activity, such as requesting a demo, registering at a web site, beginning a trial, completing a purchase, etc. Many marketing platforms may allow advertisers to place bids using one or more different metrics. For advertisers, determining a bid amount for each marketing campaign can be a difficult task.

For targeted advertising, online advertisers use various methods to target the most receptive audiences with certain traits, based on the product or service the advertiser is promoting. These traits may be demographic (e.g., economic status, sex, age, level of education, income level, employment), or they can based on the consumer's personality, attitudes, opinions, lifestyles and interests, etc. The targeting traits may also be behavioral variables, such as browsing history, purchase history, or other activity. Generally, targeted advertising attempts to deliver advertisements to consumers who are likely to have an interest in the product or service instead of those who have little or no interest, which results in a more efficient use of an organization's marketing budget by reducing wastage created by sending advertising to consumers who are unlikely to select the product or service.

Targeted advertising can be a difficult and imprecise process that requires significant time and effort to analyze the behavior and wishes of consumers. This results in targeted advertising requiring more expenses than traditional advertising. Further, targeted advertising has a limited reach to consumers, and advertisers are not always aware that consumers may change their minds, such that previously uninterested consumers or groups of consumers may become interested in a product or service, and vice versa. Additionally, as an organization grows, the organization would like to determine how best to optimize its target audience while minimizing wastage and while minimizing the resources required.

### BRIEF SUMMARY

A marketing campaign optimization system may be summarized as including at least one nontransitory processor-readable storage medium that stores at least one of processor-executable instructions or data; and at least one processor communicatively coupled to the at least one nontransitory processor-readable storage medium, in operation, the at least one processor: from time-to-time, receives campaign data from at least one marketing platform system via at least one communications network; receives financial data from at least one organization system associated with an organization via at least one communications network; autonomously analyzes the received campaign data and the received financial data to determine at least one performance metric for at least one marketing campaign of the organization; and autonomously determines a bid price for an existing marketing campaign of the organization based at least in part on the determined at least one performance metric. The at least one processor may estimate a lifetime value for customers of the organization based at least in part on the received financial data or the received campaign data. The at least one performance metric may include a value determined at one or more action steps for an organization, and the at least one processor may set the bid price for the existing marketing campaign to be equal to the determined value. The at least one processor may determine a value at one or more action steps by, for each action step, multiplying an estimated lifetime value by a determine conversion rate for the action step. The campaign data may include campaign information and performance information, the campaign information including targeting data, creative data, cost data, or placement data, and the performance information including engagement data, actions data, or price data. The financial data may include actions data, revenue data, or estimated lifetime value data.

A marketing campaign optimization system may be summarized as including at least one nontransitory processor-readable storage medium that stores at least one of processor-executable instructions or data; and at least one processor communicatively coupled to the at least one nontransitory processor-readable storage medium, in operation, the at least one processor: from time-to-time, receives campaign data from at least one marketing platform system via at least one communications network; receives financial data from at least one organization system via at least one communications network; autonomously analyzes the received campaign data and the received financial data to determine at least one performance metric for at least one marketing campaign of the organization; and autonomously generates at least one new set of marketing campaigns based at least in part on the determined at least one performance metric.

From time-to-time, the at least one processor may further autonomously activate the at least one new set of marketing campaigns on at least one marketing platform system. The at least one processor autonomously may analyze the received campaign data and the received financial data using a Bayesian algorithm. The at least one processor may autonomously analyze the received campaign data and the received financial data using a Thompson Sampling algorithm. The at least one processor may autonomously generate new targeting groups for at least one marketing campaign. The at least one processor may generate new targeting groups for at least one marketing campaign based on at least one of consumer demographics, consumer behaviors, or consumer interests. To generate new targeting groups, the at least one processor may autonomously generate a plurality of sets of consumers, each set including consumers that have completed a particular action in a list of actions, and, for each set, may autonomously generate a plurality subsets of consumers, each subset including consumers that completed the particular action within a specified period of time. To generate new targeting groups, the at least one processor may autonomously generate at least one seed audience, search at least one digital platform based at least in part on the generated seed audience, and determine new targeting groups based at least in part on the results of the search.

A marketing campaign optimization system may be summarized as including at least one processor; and at least one nontransitory processor-readable storage medium communicatively coupled to the at least one processor and that stores at least one of processor-executable instructions or data which, when executed by the at least one processor, cause the at least one processor to: receive campaign data for at least one marketing campaign via at least one communications network; receive performance data that corresponds to the at least one marketing campaign, the performance data for each marketing campaign representing at least one of a number of views of advertisements that are part of the respective marketing campaign, a number of selections of advertisements that are part of the respective marketing campaign, a number of signups for a company that is a subject of the respective marketing campaign, a number of requests for a demonstration of a product or a service that is a subject of the respective marketing campaign, a number of trials of a product or a service that is a subject of the respective marketing campaign, a number of initial payments generated by the respective marketing campaign, and a number of subsequent payments generated by the respective marketing campaign; train an artificial intelligence system with the campaign data and the performance data; and analyze the campaign data and the performance data of a subsequent one of the marketing campaigns via the trained artificial intelligence system.

Processor-executable instructions or data which, when executed by the at least one processor, may cause the at least one processor to generate a number of new marketing campaigns; and analyze the campaign data and the performance data of the new marketing campaigns via the trained artificial intelligence system. Processor-executable instructions or data which, when executed by the at least one processor, may cause the at least one processor to generate a number of new marketing campaigns; and analyze the campaign data and the performance data of the new marketing campaigns via the trained artificial intelligence system while the new marketing campaigns are live. Processor-executable instructions or data which, when executed by the at least one processor, may cause the at least one processor to optimize at least one of the marketing campaigns. Processor-executable instructions or data which, when executed by the at least one processor, may cause the at least one processor to identify behavior groups based on information collected that characterize actions taken by individuals in previous ones of the marketing campaigns. Processor-executable instructions or data which, when executed by the at least one processor, may cause the at least one processor to identify target groups based on information collected that at least one of characterizes actions that represent an interest by individuals in a company that is a subject of the marketing campaign or characterizes a level of performance of a group of individuals in the marketing campaigns.

To identify target groups based on information collected that at least one of characterizes actions that represent an interest by individuals in a company that is a subject of the marketing campaign the processor-executable instructions or data, when executed by the at least one processor, may cause the at least one processor to for each defined action, create a respective sets of individuals who took the action; and for each of the defined actions, create a number of sub-groups of individuals who performed the action on a respective date. To characterize a level of performance of a group of individuals in the marketing campaigns the processor-executable instructions or data, when executed by the at least one processor, may cause the at least one processor to identify all audiences in respective ones of a plurality of the marketing campaigns; identify at least one audience which includes a total number of individuals who has seen the respective marketing campaign that exceeds an average audience per marketing campaign; and sort the number of actions according to an ordered list of actions. To sort the number of actions according to an ordered list of actions the at least one processor may sort based on the following ordered list of actions: a number of views of advertisements that are part of the respective marketing campaign, a number of selections of advertisements that are part of the respective marketing campaign, a number of signups for a company that is a subject of the respective marketing campaign, a number of requests for a demonstration of a product or a service that is a subject of the respective marketing campaign, a number of trials of a product or a service that is a subject of the respective marketing campaign, a number of initial payments generated by the respective marketing campaign, and a number of subsequent payments generated by the respective marketing campaign. To train an artificial intelligence system with the campaign data the at least one of processor-executable instructions or data, when executed by the at least one processor, may cause the at least one processor to train the artificial intelligence system with campaign data that includes at least one of: age, gender, political affiliation, industry, income, net worth, home type, home ownership, ethnic affinity, generation, household composition, family status, office status, educational status, school, years of post-secondary education, education major, employer, job title, device on which marketing campaign was experienced, operating system of device on which marketing campaign was experienced, connections, affinity group, personal behavior, or behavior within a product. To train an artificial intelligence system with the performance data the at least one of processor-executable instructions or data, when executed by the at least one processor, may cause the at least one processor to train the artificial intelligence system with performance data that includes at least one of: a number of impressions, a number of opens, a number of clicks, a number of views, a number of video views, a number of reactions, a number of shares, a number of comments, or a number of replies. Processor-executable instructions or data which, when executed by the at least one processor, may cause the at least one processor to autonomously place creative of at one of the marketing campaigns into at least one of a broadcast distribution system, a multicast distribution system, or a unicast distribution system.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 is a schematic diagram of various components of an artificial intelligence marketing campaign optimization system, according to one illustrated implementation.

FIG. 2 is a schematic diagram of a campaign data database of a marketing platform operatively coupled to an artificial intelligence marketing campaign optimization system, according to one non-limiting illustrated implementation.

FIG. 3 is a schematic diagram of a financial data database of an organization operatively coupled to an artificial intelligence marketing campaign optimization system, according to one non-limiting illustrated implementation.

FIG. 4 is a flow diagram that depicts a sequential flow of marketing actions for an organization, according to one non-limiting illustrated implementation.

FIG. 5 is a flow diagram that depicts a process for autonomously setting bid prices for advertisements of a marketing campaign, according to one non-limiting illustrated implementation.

FIG. 6 is a schematic diagram for a target finder component of an artificial intelligence marketing campaign optimization system, according to one non-limiting illustrated implementation.

FIG. 7 is a flow diagram for a method of operating a behavior subcomponent of a target finder component of an artificial intelligence marketing campaign optimization system to autonomously find behavior groups to target, according to one non-limiting illustrated implementation.

FIG. 8 is a flow diagram for a method of operating an interests subcomponent of a target finder component of an artificial intelligence marketing campaign optimization system to autonomously identify top performing audiences for a targeted marketing campaign, according to one non-limiting illustrated implementation.

FIG. 9 is flow diagram for a method of operating a test generation subsystem of an artificial intelligence marketing campaign optimization system to autonomously generate targeting tests, according to one non-limiting illustrated implementation.

FIG. 10 is a block diagram of an example processor-based device that may be used to implement one or more of the systems or subsystems described herein, according to one non-limiting illustrated implementation.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with computer systems, server computers, and/or communications networks have not been shown or described in detail to avoid unnecessarily obscuring descriptions of the implementations.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The headings and Abstract of the Disclosure provided herein are for convenience only and do not interpret the scope or meaning of the implementations.

One or more implementations of the present disclosure are directed to an artificial intelligence (AI) marketing campaign optimization platform or system that automates and optimizes bidding, audience matching, and retargeting of marketing campaigns to meet business goals on digital platforms (e.g., Facebook®, Instagram®, Google®). The artificial intelligence campaign optimization platform may autonomously plan and manage advertising campaigns for a plurality of organizations on one or more digital platforms. As discussed further below, the campaign optimization platform may provide autonomous bidding, autonomous audience matching, autonomous creative optimization, as well as tailored dashboard analytics that allow organizations to know exactly how their marketing campaigns are performing throughout the day. The autonomous bidding features allow an organization (e.g., company) to target their highest value customers to reach their growth targets or other goals. A bidding automation tool optimizes every dollar spent on advertisements placed on digital platforms to ensure organizations are paying the optimum price for the optimum audience. An audience matching tool autonomously reveals new interest and audience groups, and identifies new keyword groups. The techniques described herein go beyond basic “lookalike” audiences to continually uncover new top performing groups. In at least some implementations, the campaign optimization platform discussed herein may include an autonomous creative optimization tool that runs numerous (e.g., hundreds, thousands) creative tests across a plurality of advertising channels, analyzes the performance, and identifies creative that works best for an organization's audience. The various features of the artificial intelligence marketing campaign optimization platform of the present disclosure are discussed below with reference to the drawings.

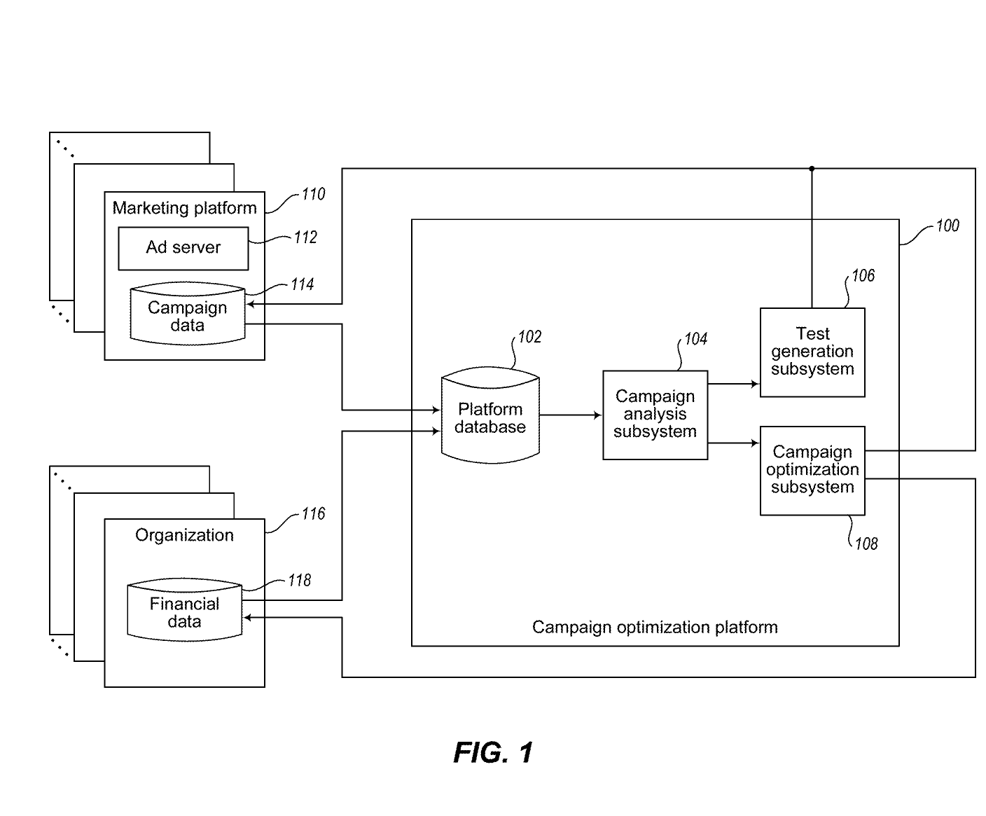

FIG. 1 is a schematic diagram of an artificial intelligence marketing campaign optimization system 100 (“campaign optimization system”). The campaign optimization system 100 includes a platform database 102, a campaign analysis subsystem 104, a test generation subsystem 106, and a campaign optimization subsystem 108. The campaign optimization system 100 may be operatively coupled to financial databases 118 of a number of organizations 116, also referred to herein as companies or customers. The campaign optimization system 100 may also be operatively coupled to campaign data databases 114 and ad servers 112 of one or more marketing platforms 110.

Generally, in operation, the campaign optimization system 100 reads in campaign data from the campaign database 114 and financial data from the financial database 118 for each of one or more organizations, and stores such data in the platform database 102. The campaign optimization system 100 may read in the data at one or more regular or irregular intervals (e.g., continuously, on demand, hourly, weekly). The campaign analysis subsystem 104 autonomously runs analyses on the data to determine the performance (e.g., one or more performance metrics) of one or more marketing campaigns. Based on the results of such analyses, the test generation subsystem 106 autonomously designs new sets of marketing campaigns to test, creates such marketing campaigns, and runs live tests on the newly generated marketing campaigns. The campaign optimization subsystem 108 may also autonomously determine and select a correct price (e.g., bid price) and creative to pair with existing campaigns based on the analysis from the campaign analysis subsystem. Additionally, in at least some implementations, the campaign optimization subsystem 108 autonomously adjusts the allocation of spend on better performing advertisement sets.

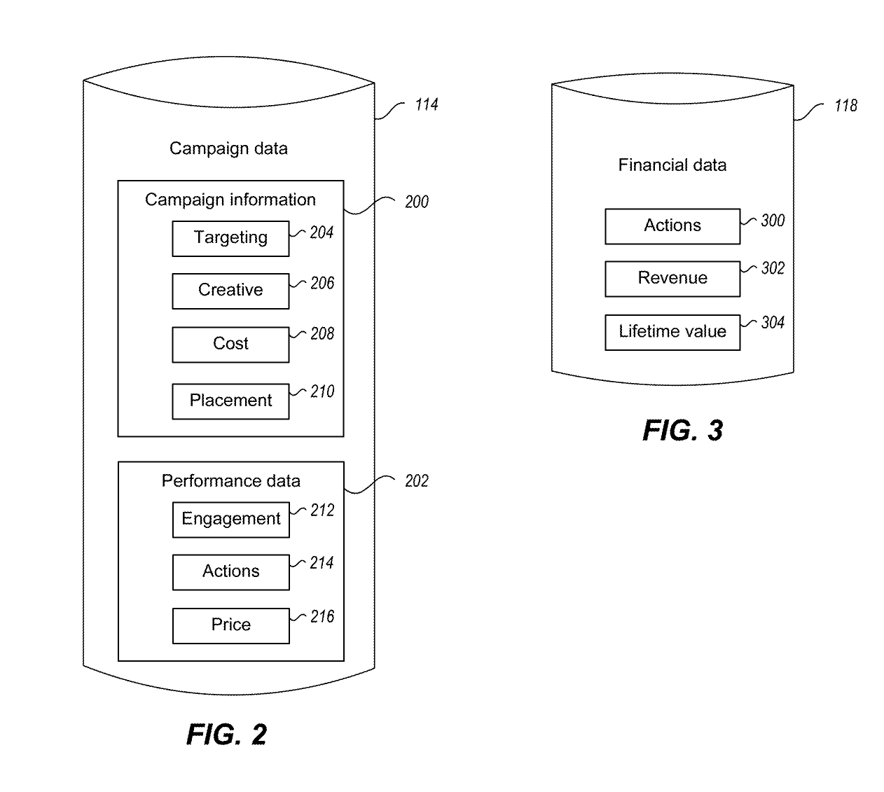

FIG. 2 is a detailed schematic diagram of the campaign data database 114 also shown in FIG. 1. The data from the campaign data database 114 may be received directly from the marketing platform 110 (FIG. 1) via a suitable communications network (e.g., the Internet). The campaign data may include campaign information 200 and performance data 202, for example.

Campaign information 200 may include targeting information 204, which specifies who the campaign targets. Examples of targeting information 204 may include information relating to age, gender, political affiliation, industry, income, net worth, home type, homeownership, ethnic affinity, induration, household composition, family status, office status, education status, school, college years, education major, employer, job title, device, operating system, connections, affinity group, personal behavior, behavior within a product, etc.

Campaign information 200 may also include creative information 206, which specifies the creative for each campaign. Examples of creative information 206 include headline, description, copy, image(s), audio, video, etc.

Campaign information 200 may also include cost information 208, which specifies the price to run the marketing campaign.

Campaign information 200 may also include placement information 210, which specifies the placement (e.g., Facebook®, Google®, email) of the campaign. Examples of placement information 210 may include channel, position, size, etc.

Performance data 202 may include engagement data 212, actions data 214, and price data 216. Examples of engagement data include impressions, opens, clicks, views, video views, reactions, shares, comments, replies, etc. Examples of actions data 214 include any data about actions taken by a consumer after viewing the advertisement, such as registrations, demo requests, purchases, etc. Actions data 214 may be represented as a number of goal events by people who have seen or clicked on the marketing campaign. Goal events may be defined per organization. Price data 216 may include cost per impression, cost per click, cost per purchase, etc.

FIG. 3 is a detailed schematic diagram of the financial data database 118 also shown in FIG. 1. The data from the financial data database 118 may be received directly from one or more systems of an organization 116 (FIG. 1) via a suitable communications network. The financial data may include actions data 300, revenue data 302, and lifetime value data 304. Actions data 300 may include the number of actions taken by users who have interacted (e.g., viewed, clicked) with the marketing campaign. Revenue data 302 may include the revenue associated with each action. For example, revenue data 302 may include revenue associated with a first purchase, revenue associated with recurring purchases, and/or revenue from advertisements that have been viewed or clicked. Lifetime value data 304 may include a projected lifetime value of each user, as defined by the organization.

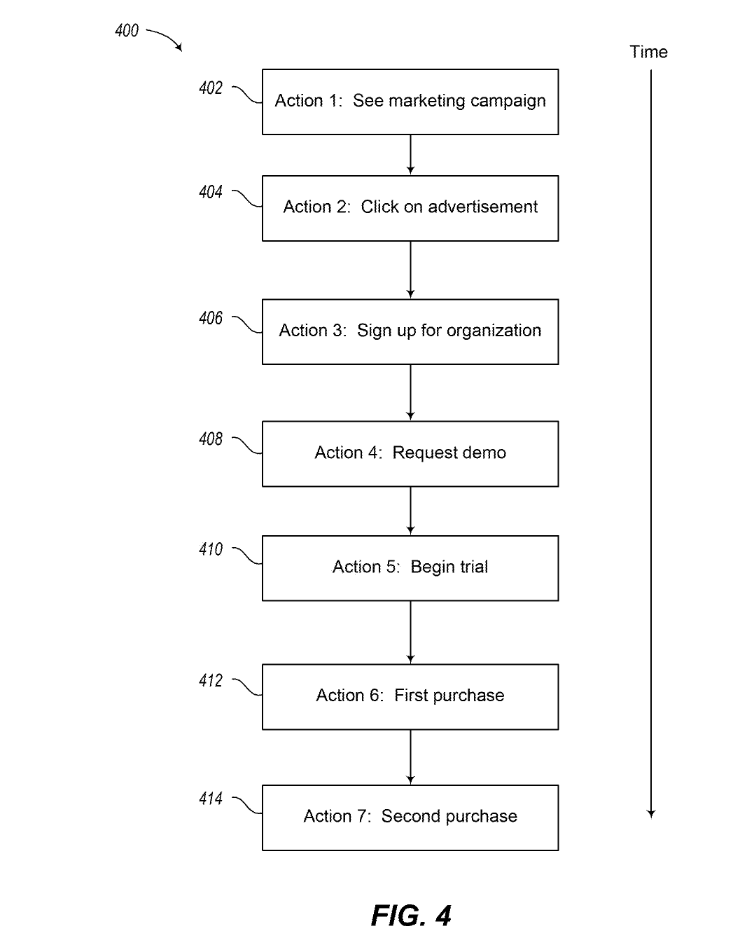

FIG. 4 is a flow diagram that depicts a sequential flow 400 of marketing actions of consumers for an example organization. The actions may begin with the interactions between a user and the marketing campaign, and may result in estimations or projections of lifetime value, as discussed further below.

In the illustrated example, seven actions are defined for a particular organization. Action 1, designated with reference numeral 402 in FIG. 4, is the user seeing the marketing campaign (e.g., viewing email, viewing display banner, viewing video). Action 2, designated with reference numeral 404, is the user clicking on or otherwise selecting an advertisement of the marketing campaign. Action 3, designated with reference numeral 406, is the user signing up or registering with the organization. Action 4, designated with reference numeral 408, is the user requesting a demo of a product or service offered by the organization. Action 5, designated with reference numeral 410, is the user beginning a trial use period for a product or service offered by the organization. Action 6, designated with reference numeral 412, is the user making a first purchase of a product or service offered by the organization. Action 7, designated with reference numeral 414, is the user making a second purchase of a product or service offered by the organization. It should be appreciated that each organization may have different defined actions. For example, an organization that does not offer demos or trial periods would not include Actions 4 and 5. Since the number of consumers performing each of the Actions 1-7 decreases from Action 1 toward Action 7, the sequential list of actions may be referred to herein as a “marketing funnel” which is conceptually wider at Action 1 and narrows toward Action 7, similar to a funnel.

The campaign optimization system 100 may estimate the lifetime value of a consumer in at least three ways. In at least some implementations, each organization may select which of the at least three ways the campaign optimization system 100 estimates the lifetime value.

A first method of estimating lifetime value is using a default number of purchases. For this method, the organization sets a default number of purchases for each of their customers. The campaign optimization system 100 multiplies the value of the first purchase by the default number of purchases to calculate an estimated lifetime value (eLTV). That is, eLTV=(revenue of first purchase)×(default number of purchases).

A second method of estimating lifetime value is using a ratio between sets of purchases. For this method, the campaign optimization system 100 estimates the default number of purchases by each customer by using a ratio between the number of first purchases and the number of second purchases. In particular, the campaign optimization system 100 estimates the default number of purchases according to the following formula:

default number of purchases=1/(1−(number of second purchases)/(number of first purchases))

A third method of estimating lifetime value is using an organization's internal calculations. For this method, the campaign optimization system 100 reads in the organization's estimate of lifetime value through the financial database 118 (see FIGS. 1 and 2 discussed above).

The campaign optimization system 100 uses the estimated lifetime value to determine one or more conversion rates (CVR). The CVR is defined as the percentage of users who continue from one step or action (see FIG. 4) to a subsequent step. The CVR may be set at any two levels of the marketing funnel. For example, the CVR between Action 2 and Action 4 may be defined as the number of users at Action 4 divided by the number of users at Action 2.

In at least some implementations, the campaign optimization system 100 determines value at each action step in the marketing funnel. As discussed above, each organization may have a unique marketing funnel, depending on the particular methods used by the organization to market and sell its products or services. Determining the value at each action step in the marketing funnel advantageously allows the campaign optimization system 100 to compare the value of users to the price paid for the marketing campaign. This value is determined by multiplying the estimated lifetime value (eLTV) by the conversion rate (CVR).

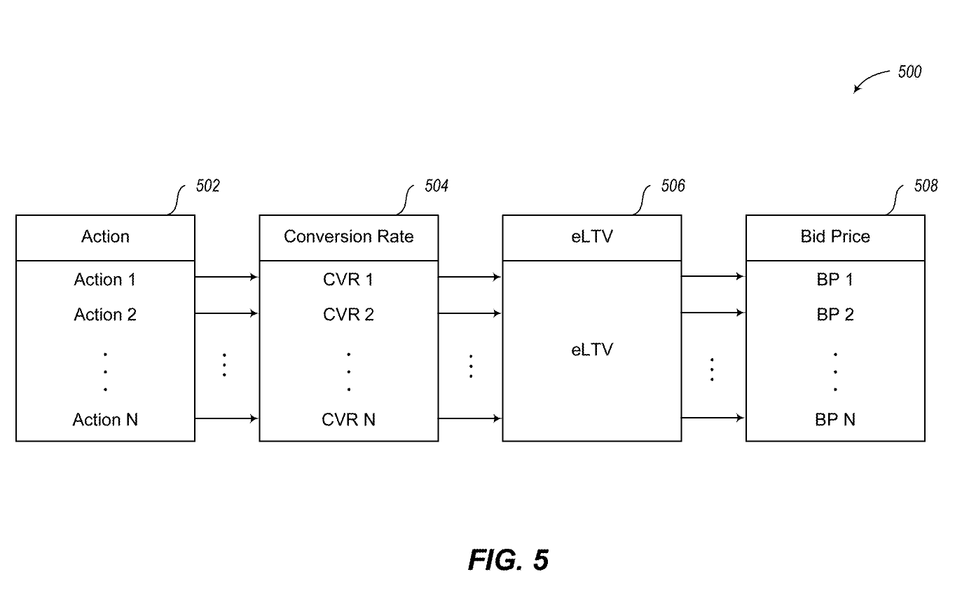

FIG. 5 is a flow diagram that depicts a method 500 for autonomously setting bid prices for a marketing campaign of an organization. As shown, a plurality of action 502, designated actions 1-N are defined for an organization. Using the method discussed above, a plurality of conversion rates 504, designated conversion rates 1-N, are determined, one for each of the plurality of actions 502. Each of the conversion rates 504 is multiplied by the estimated lifetime value 506 to provide respective bid prices 508, designated BP 1-N, for each of the actions 1-N.

For example, an organization may have an estimated lifetime value for a marketing campaign of $100. The conversion rate between an action step 3 (e.g., register at an organization's website) and an action step 6 (e.g., first purchase) may be 20%. Thus, the value at action step 3 may be determined to be $100×20%, or $20.

In practice, advertisers set a price they are willing to pay for a particular advertisement. Typically, the advertisement is sold via a bidding process, and the advertisement is sold to the organization that has the highest willingness to pay. This may be defined as the “bid price.” In at least some implementations, the campaign optimization system 100 sets the bid price equal to the determined value at each particular action step in the marketing funnel (see FIGS. 4 and 5).

Marketing platforms may allow the advertiser (organization) to set bid prices at various action steps or levels. For example, some marketing platforms may allow advertisers to set bid prices at the purchase level, while others may allow advertisers to set bid prices at the click or impression level. Additionally, some marketing platforms may allow advertisers to select bid prices at a plurality of levels (e.g., purchase and click, click and impression).

Based on the requirements of each particular marketing platform, the campaign optimization system 100 determines the bid price using the method shown in FIG. 5 for particular points in the marketing funnel. For example, if an advertiser wants to advertise on a first marketing platform that allows advertisers to set bid prices at the purchase level and a second marketing platform that allows advertisers to set bid prices at the click level, the campaign optimization system 100 autonomously determines bid prices for the marketing campaign at both the purchase level and click level for the organization.

Continuing with the example above, if a particular marketing platform allows an advertiser to set a bid price per second purchase, the campaign optimization system 100 autonomously sets the bid price equal to the determined value of the second purchase action step in the marketing funnel for the organization. Similarly, if a marketing platform allows an advertiser to set a bid price at a “click on advertisement” level, the campaign optimization system 100 autonomously sets the bid price equal to the determined value of a “click on advertisement” action step in the marketing funnel for the organization.

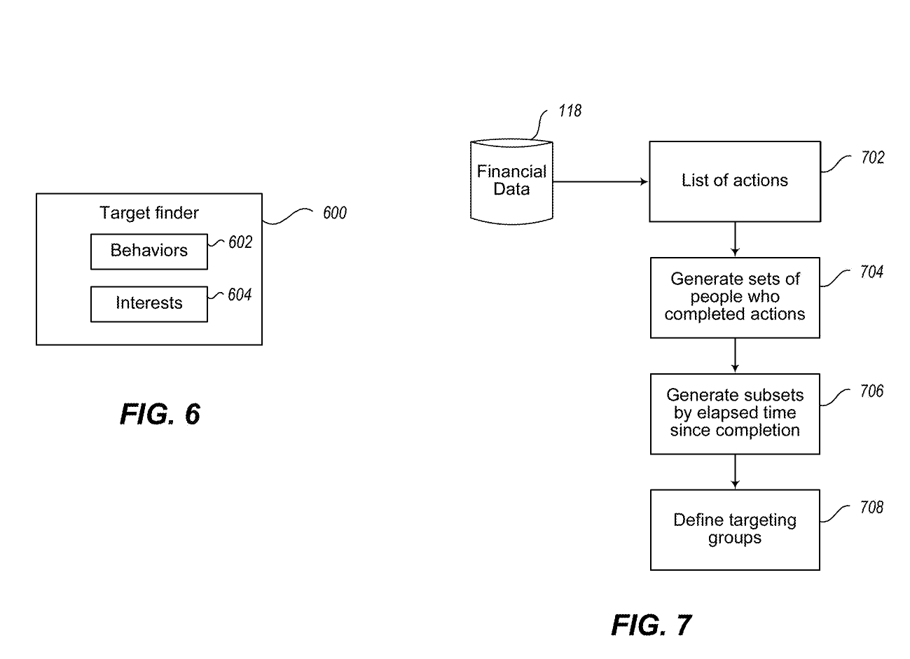

FIG. 6 is a schematic diagram for a target finder component 600 (or “target finder”) of the campaign optimization system 100. For example, the target finder 600 may be a subcomponent of the test generation subsystem 106 shown in FIG. 1. Generally, the target finder 600 is operative to autonomously find and expand target audiences for marketing campaigns of an organization.

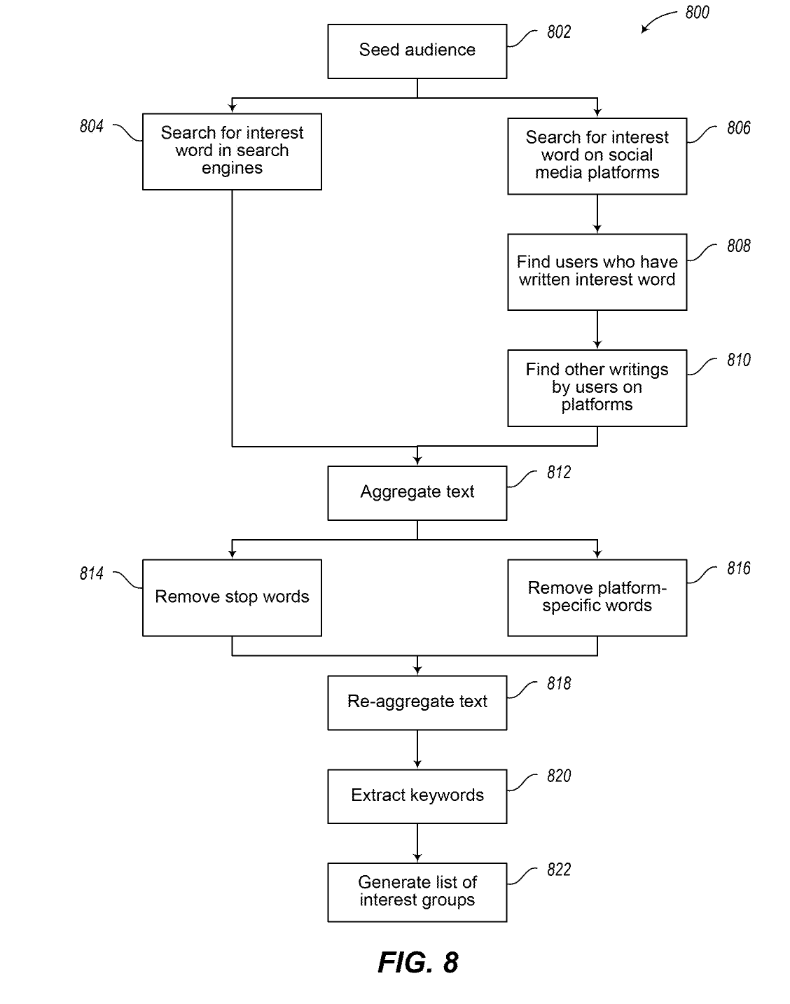

The campaign optimization system 100 defines targeting as a grouping of people who view a marketing campaign. This may be based on demographic information (e.g., age, gender, location), behavior (e.g., have previously viewed, have previously purchased), or interests (e.g., dogs, cats, photography). The target finder 600 includes at least two subcomponents, a behaviors subcomponent 602 and an interests subcomponent 604. The operations of the behavior subcomponent 602 and the interests subcomponent 604 are discussed below with reference to FIGS. 7 and 8, respectively.

FIG. 7 is a flow diagram for a method of operating the behavior subcomponent 602 of the target finder 600 to autonomously find behavior groups to target based on previous actions. At 702, the behavior subcomponent 602 receives a list of actions from the financial database 118. For example, the list of actions may include the example Actions 1-7 shown in FIG. 4. At 704, for each action in the list, the behavior subcomponent 602 generates sets of people who have completed each of the actions. At 706, the behavior subcomponent 706 generates subsets for each of the actions, with each subset comprising a grouping by elapsed time since the action was completed. For example, for each action (e.g., purchase), 30 subsets may be created, defined by the number of days (e.g., 1-30 days) since the consumer completed that action. As another example, for an action “viewed campaign,” there may be 30 subgroups for “viewed campaign within 1 day,” “viewed campaign within 2 days and not within 1 day,” viewed campaign within 3 days and not within 1 or 2 days,” etc.

At 708, the behavior component 602 may define behavior targeting groups based on the defined subgroups. For example, for N actions and M subgroups, the behavior component may define N×M behavior targeting groups that may be used by the test generation subsystem 106 (FIG. 1) to generate, run, and test new marketing campaigns, as discussed herein.

FIG. 8 is a flow diagram for a method 800 of operating the interests subcomponent 604 of the target finder 600 to autonomously identify top performing audiences for a targeted marketing campaign. Generally, the interests subcomponent 604 autonomously finds new interests groups for an organization to target based on information about the organization. This feature may be referred to as “audience matching.”

To expand an audience, the interests subcomponent 604 may first identify a “seed audience” or seed keyword. This may be achieved in at least two ways. In at least some implementations, the organization's name may be used as a seed audience. In at least some implementations, the seed audience may be determined by autonomously identifying current top performing audience groups in marketing campaigns.

To identify the top performing audiences, the interests subcomponent 604 may first find all audiences in current marketing campaigns for an organization. Then, the interest subcomponent 604 may list audiences where the total number of people who have seen the campaign is greater than the average per audience group. Next, the interests subcomponent 604 may sort by the number of actions at the furthest possible point within the marketing funnel for the organization. For example, if audiences have data for funnel action step 1 and funnel action step 2 of a marketing funnel, the interests subcomponent 604 may sort by funnel action step 2. Then, the interests subcomponent 604 may select a number of the top performing audiences from the sorted list. The particular number of audiences to select may be set by the interests subcomponent 604, or may be selectable by a user associated with the campaign optimization system 100 and/or a user of the organization.

The method 800 begins with a seed audience or interest word 802, as discussed above. At 804, the interests subcomponent 604 searches for the interest word in search engines (e.g., Google®, Bing®). At 806, the interests subcomponent 604 searches for the interest word on social media platforms (e.g., Facebook®, Twitter®, LinkedIn®). At 808, the interests subcomponent 604 finds users that have written the interest keyword on the social media platforms. At 810, the interests subcomponent 604 finds all other writings by such users on the social media platforms.

At 812, the interests subcomponent 604 aggregates the text from the searches together. At 814, the interests subcomponent 604 may remove all “stop words,” such as the words “and,” “or,” or “the.” At 816, the interests subcomponent 604 may remove all platform-specific words (e.g., “RT” on Twitter®). At 818, the interests subcomponent 604 may re-aggregate the text.

At 820, the interests subcomponent 604 may extract keywords from the re-aggregated text. For example, the interests subcomponent 604 may run the text through a rapid automatic keyword extraction (RAKE) algorithm to extract the most relevant keywords from the text. At 822, the interests subcomponent 604 may generate a list of interest groups based on the extracted keywords, which groups may be used by the test generation subsystem 106, as discussed herein.

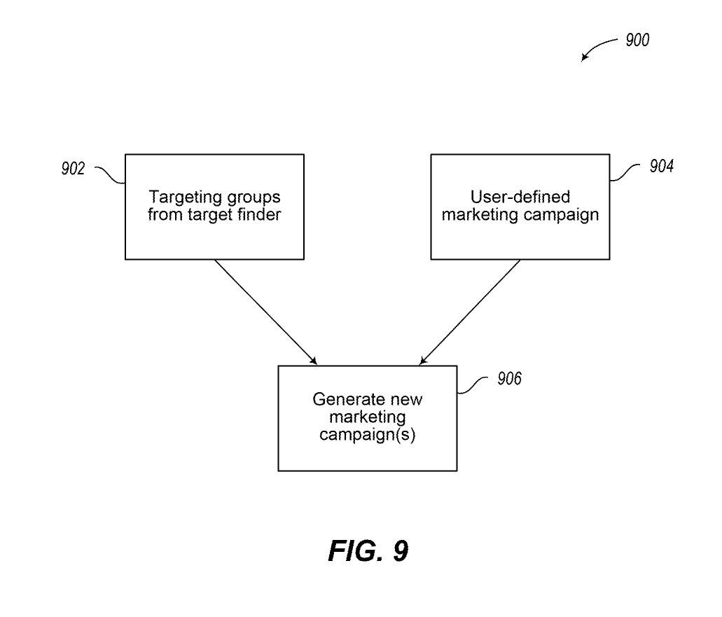

FIG. 9 is flow diagram for a method of operating the test generation subsystem 106 (FIG. 1) of the campaign optimization system 100 to autonomously generate targeting tests. The campaign optimization system 100 utilizes targeting groups 902 from the target finder 600 and user-defined marketing campaign settings 904. At 906, after determining the targeting groups in behavior or interests, the campaign optimization system 100 autonomously creates new marketing campaigns. These new marketing campaigns have targeting 902 that is defined from the target finder 600. The other settings 904 for the marketing campaign, which may vary by marketing platform and by type of marketing campaign, may be extracted from a user-defined marketing campaign.

The test generation subsystem 106 of the campaign optimization system 100 may then autonomously, without input from a user, set the new marketing campaigns live (i.e., activate) on one or more marketing platforms. The campaign optimization system 100 then autonomously collects data for the new campaigns, analyzes the results, and generates new campaigns, etc. Thus, without user intervention, the campaign optimization system 100 is able to periodically (e.g., continuously, from time-to-time) autonomously generate and optimize new marketing campaigns for an organization to target audiences that may change (e.g., expand, shift) over time.

In at least some implementations, the campaign analysis subsystem 104, test generation subsystem 106, and/or campaign optimization subsystem 108 of the campaign optimization system 100 may utilize various analyses techniques to optimize marketing campaigns. In at least some implementations, the campaign optimization system 100 may apply a “multi-arm bandits” problem to determine spend allocation. Such advantageously enables the system to autonomously distribute advertising spend proportionally to the probability of improved performance of that spend against the rest of the campaigns. For example, in at least some implementations, the campaign optimization system 100 may utilize a Bayesian algorithm, such as Thomas Sampling (TS), also referred to as Bayesian posterior sampling, Bayesian A/B testing, Bayesian A/B/C testing, etc., to test and optimize marketing campaigns. Non-limiting example algorithms that may be used by the campaign optimization system 100 are described in Agrawal S. and Goyal N., “Analysis of Thompson Sampling for the multi-armed bandit problem.” In Proceedings of the 25th Annual Conference on Learning Theory (COLT), 2012; Miller, Evan. (Oct. 1, 2015). “Formulas for Bayesian A/B Testing,” retrieved from evanmiller[dot]org; and Agrawal, S. (Feb. 1, 2016) Lecture 4: Thompson Sampling (part 1),” retrieved from bandits.wikischolars.columbia[dot]edu, the contents of which are incorporated herein by reference.

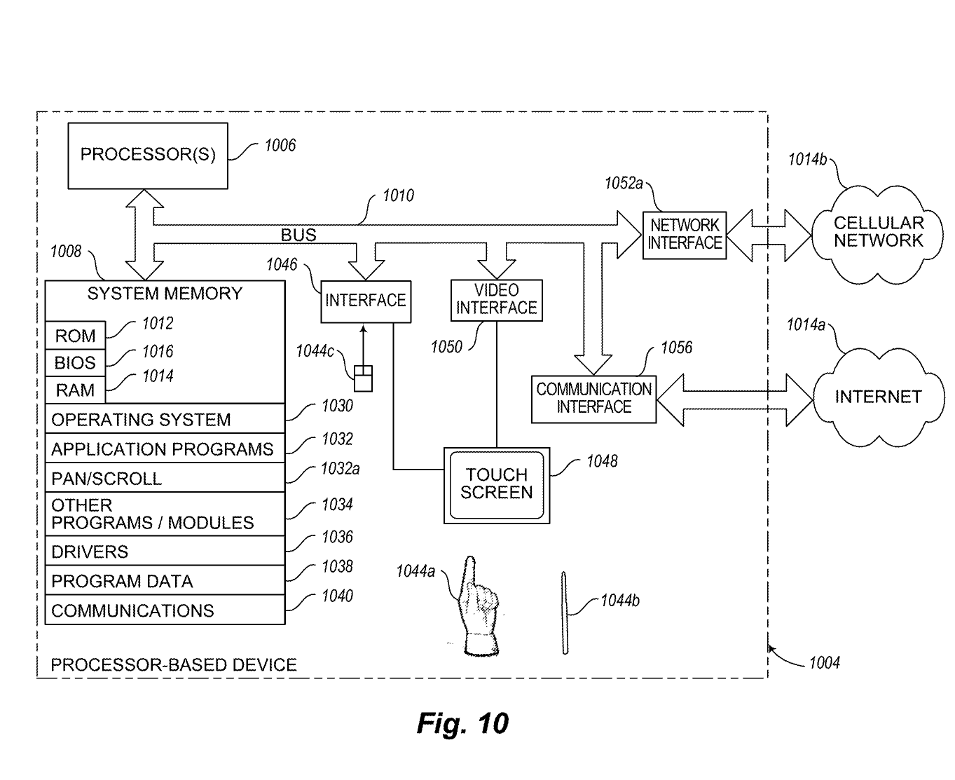

FIG. 10 shows a processor-based device 1004 suitable for implementing various embodiments described herein. Although not required, some portion of the embodiments will be described in the general context of processor-executable instructions or logic, such as program application modules, objects, or macros being executed by one or more processors. Those skilled in the relevant art will appreciate that the described embodiments, as well as other embodiments, can be practiced with various processor-based system configurations, including handheld devices, such as smartphones and tablet computers, wearable devices, multiprocessor systems, microprocessor-based or programmable consumer electronics, personal computers (“PCs”), network PCs, minicomputers, mainframe computers, and the like.

The processor-based device 1004 may, for example, take the form of a smartphone or tablet computer, which includes one or more processors 1006, a system memory 1008 and a system bus 1010 that couples various system components including the system memory 1008 to the processor(s) 1006. The processor-based device 1004 will at times be referred to in the singular herein, but this is not intended to limit the embodiments to a single system, since in certain embodiments, there will be more than one system or other networked computing device involved. Non-limiting examples of commercially available systems include, but are not limited to, ARM processors from a variety of manufactures, Core microprocessors from Intel Corporation, U.S.A., PowerPC microprocessor from IBM, Sparc microprocessors from Sun Microsystems, Inc., PA-RISC series microprocessors from Hewlett-Packard Company, 68xxx series microprocessors from Motorola Corporation.

The processor(s) 1006 may be any logic processing unit, such as one or more central processing units (CPUs), microprocessors, digital signal processors (DSPs), application-specific integrated circuits (ASICs), field programmable gate arrays (FPGAs), etc. Unless described otherwise, the construction and operation of the various blocks shown in FIG. 10 are of conventional design. As a result, such blocks need not be described in further detail herein, as they will be understood by those skilled in the relevant art.

The system bus 1010 can employ any known bus structures or architectures, including a memory bus with memory controller, a peripheral bus, and a local bus. The system memory 1008 includes read-only memory (“ROM”) 1012 and random access memory (“RAM”) 1014. A basic input/output system (“BIOS”) 1016, which can form part of the ROM 1012, contains basic routines that help transfer information between elements within processor-based device 1004, such as during start-up. Some embodiments may employ separate buses for data, instructions and power.

The processor-based device 1004 may also include one or more solid state memories, for instance Flash memory or solid state drive (SSD) 1018, which provides nonvolatile storage of computer-readable instructions, data structures, program modules and other data for the processor-based device 1004. Although not depicted, the processor-based device 1004 can employ other nontransitory computer- or processor-readable media, for example a hard disk drive, an optical disk drive, or memory card media drive.

Program modules can be stored in the system memory 1008, such as an operating system 1030, one or more application programs 1032, other programs or modules 1034, drivers 1036 and program data 1038.

The application programs 1032 may, for example, include panning/scrolling 1032a. Such panning/scrolling logic may include, but is not limited to logic that determines when and/or where a pointer (e.g., finger, stylus, cursor) enters a user interface element that includes a region having a central portion and at least one margin. Such panning/scrolling logic may include, but is not limited to logic that determines a direction and a rate at which at least one element of the user interface element should appear to move, and causes updating of a display to cause the at least one element to appear to move in the determined direction at the determined rate. The panning/scrolling logic 1032a may, for example, be stored as one or more executable instructions. The panning/scrolling logic 1032a may include processor and/or machine executable logic or instructions to generate user interface objects using data that characterizes movement of a pointer, for example data from a touch-sensitive display or from a computer mouse or trackball, or other user interface device.

The system memory 1008 may also include communications programs 1040, for example a server and/or a Web client or browser for permitting the processor-based device 1004 to access and exchange data with other systems such as user computing systems, Web sites on the Internet, corporate intranets, or other networks as described below. The communications program 1040 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. A number of servers and/or Web clients or browsers are commercially available such as those from Mozilla Corporation of California and Microsoft of Washington.

While shown in FIG. 10 as being stored in the system memory 1008, the operating system 1030, application programs 1032, other programs/modules 1034, drivers 1036, program data 1038 and server and/or browser 1040 can be stored on any other of a large variety of nontransitory processor-readable media (e.g., hard disk drive, optical disk drive, SSD and/or flash memory.

A user can enter commands and information via a pointer, for example through input devices such as a touch screen 1048 via a finger 1044a, stylus 1044b, or via a computer mouse or trackball 1044c which controls a cursor. Other input devices can include a microphone, joystick, game pad, tablet, scanner, biometric scanning device, etc. These and other input devices (i.e., “I/O devices”) are connected to the processor(s) 1006 through an interface 1046 such as a touch-screen controller and/or a universal serial bus (“USB”) interface that couples user input to the system bus 1010, although other interfaces such as a parallel port, a game port or a wireless interface or a serial port may be used. The touch screen 1048 can be coupled to the system bus 1010 via a video interface 1050, such as a video adapter to receive image data or image information for display via the touch screen 1048. Although not shown, the processor-based device 1004 can include other output devices, such as speakers, vibrator, haptic actuator or haptic engine, etc.

The processor-based device 104 operates in a networked environment using one or more of the logical connections to communicate with one or more remote computers, servers and/or devices via one or more communications channels, for example, one or more networks 1014a, 1014b. These logical connections may facilitate any known method of permitting computers to communicate, such as through one or more LANs and/or WANs, such as the Internet, and/or cellular communications networks. Such networking environments are well known in wired and wireless enterprise-wide computer networks, intranets, extranets, the Internet, and other types of communication networks including telecommunications networks, cellular networks, paging networks, and other mobile networks.

When used in a networking environment, the processor-based device 1004 may include one or more network, wired or wireless communications interfaces 1052a, 1056 (e.g., network interface controllers, cellular radios, WI-FI radios, Bluetooth radios) for establishing communications over the network, for instance the Internet 1014a or cellular network.

In a networked environment, program modules, application programs, or data, or portions thereof, can be stored in a server computing system (not shown). Those skilled in the relevant art will recognize that the network connections shown in FIG. 10 are only some examples of ways of establishing communications between computers, and other connections may be used, including wirelessly.

For convenience, the processor(s) 1006, system memory 1008, and network and communications interfaces 1052a, 1056 are illustrated as communicably coupled to each other via the system bus 1010, thereby providing connectivity between the above-described components. In alternative embodiments of the processor-based device 1004, the above-described components may be communicably coupled in a different manner than illustrated in FIG. 10. For example, one or more of the above-described components may be directly coupled to other components, or may be coupled to each other, via intermediary components (not shown). In some embodiments, system bus 1010 is omitted and the components are coupled directly to each other using suitable connections.

The foregoing detailed description has set forth various implementations of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one implementation, the present subject matter may be implemented via Application Specific Integrated Circuits (ASICs). However, those skilled in the art will recognize that the implementations disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

Those of skill in the art will recognize that many of the methods or algorithms set out herein may employ additional acts, may omit some acts, and/or may execute acts in a different order than specified.

In addition, those skilled in the art will appreciate that the mechanisms taught herein are capable of being distributed as a program product in a variety of forms, and that an illustrative implementation applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory.

The various implementations described above can be combined to provide further implementations. Aspects of the implementations can be modified, if necessary, to employ systems, circuits and concepts of the various patents, applications and publications to provide yet further implementations.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A marketing campaign optimization system, comprising:
at least one nontransitory processor-readable storage medium that stores at least one of processor-executable instructions or data; and
at least one processor communicatively coupled to the at least one nontransitory processor-readable storage medium, in operation, the at least one processor:
from time-to-time,
receives campaign data from at least one marketing platform system via at least one communications network;
receives financial data from at least one organization system associated with an organization via at least one communications network;
autonomously analyzes the received campaign data and the received financial data to determine at least one performance metric for at least one marketing campaign of the organization; and
autonomously determines a bid price for an existing marketing campaign of the organization based at least in part on the determined at least one performance metric.

2. The marketing campaign optimization system of claim 1 wherein the at least one processor estimates a lifetime value for customers of the organization based at least in part on the received financial data or the received campaign data.

3. The marketing campaign optimization system of claim 1 wherein the at least one performance metric comprises a value determined at one or more action steps for an organization, and the at least one processor sets the bid price for the existing marketing campaign to be equal to the determined value.

4. The marketing campaign optimization system of claim 3 wherein the at least one processor determines a value at one or more action steps by, for each action step, multiplying an estimated lifetime value by a determine conversion rate for the action step.

5. The marketing campaign optimization system of claim 1 wherein the campaign data comprises campaign information and performance information, the campaign information comprising targeting data, creative data, cost data, or placement data, and the performance information comprising engagement data, actions data, or price data.

6. The marketing campaign optimization system of claim 1 wherein the financial data comprises actions data, revenue data, or estimated lifetime value data.

7. A marketing campaign optimization system, comprising:
at least one nontransitory processor-readable storage medium that stores at least one of processor-executable instructions or data; and
at least one processor communicatively coupled to the at least one nontransitory processor-readable storage medium, in operation, the at least one processor:
from time-to-time,
receives campaign data from at least one marketing platform system via at least one communications network;
receives financial data from at least one organization system via at least one communications network;
autonomously analyzes the received campaign data and the received financial data to determine at least one performance metric for at least one marketing campaign of the organization; and
autonomously generates at least one new set of marketing campaigns based at least in part on the determined at least one performance metric.

8. The marketing campaign optimization system of claim 7 wherein, from time-to-time, the at least one processor further autonomously activates the at least one new set of marketing campaigns on at least one marketing platform system.

9. The marketing campaign optimization system of claim 7 wherein the at least one processor autonomously analyzes the received campaign data and the received financial data using a Bayesian algorithm.

10. The marketing campaign optimization system of claim 7 wherein the at least one processor autonomously analyzes the received campaign data and the received financial data using a Thompson Sampling algorithm.

11. The marketing campaign optimization system of claim 7 wherein the at least one processor autonomously generates new targeting groups for at least one marketing campaign.

12. The marketing campaign optimization system of claim 11 wherein the at least one processor generates new targeting groups for at least one marketing campaign based on at least one of consumer demographics, consumer behaviors, or consumer interests.

13. The marketing campaign optimization system of claim 11 wherein, to generate new targeting groups, the at least one processor autonomously generates a plurality of sets of consumers, each set including consumers that have completed a particular action in a list of actions, and, for each set, autonomously generates a plurality subsets of consumers, each subset including consumers that completed the particular action within a specified period of time.

14. The marketing campaign optimization system of claim 11 wherein, to generate new targeting groups, the at least one processor autonomously generates at least one seed audience, searches at least one digital platform based at least in part on the generated seed audience, and determines new targeting groups based at least in part on the results of the search.

15. A marketing campaign optimization system, comprising:
at least one processor; and
at least one nontransitory processor-readable storage medium communicatively coupled to the at least one processor and that stores at least one of processor-executable instructions or data which, when executed by the at least one processor, cause the at least one processor to:
receive campaign data for at least one marketing campaign via at least one communications network;
receive performance data that corresponds to the at least one marketing campaign, the performance data for each marketing campaign representing at least one of a number of views of advertisements that are part of the respective marketing campaign, a number of selections of advertisements that are part of the respective marketing campaign, a number of signups for a company that is a subject of the respective marketing campaign, a number of requests for a demonstration of a product or a service that is a subject of the respective marketing campaign, a number of trials of a product or a service that is a subject of the respective marketing campaign, a number of initial payments generated by the respective marketing campaign, and a number of subsequent payments generated by the respective marketing campaign;
train an artificial intelligence system with the campaign data and the performance data; and
analyze the campaign data and the performance data of a subsequent one of the marketing campaigns via the trained artificial intelligence system.

16. The marketing campaign optimization system of claim 15 wherein processor-executable instructions or data which, when executed by the at least one processor, cause the at least one processor to:
generate a number of new marketing campaigns; and
analyze the campaign data and the performance data of the new marketing campaigns via the trained artificial intelligence system.

17. The marketing campaign optimization system of claim 15 wherein processor-executable instructions or data which, when executed by the at least one processor, cause the at least one processor to:
generate a number of new marketing campaigns; and
analyze the campaign data and the performance data of the new marketing campaigns via the trained artificial intelligence system while the new marketing campaigns are live.

18. The marketing campaign optimization system of claim 15 wherein processor-executable instructions or data which, when executed by the at least one processor, cause the at least one processor to:
optimize at least one of the marketing campaigns.

19. The marketing campaign optimization system of claim 15 wherein processor-executable instructions or data which, when executed by the at least one processor, cause the at least one processor to:
identify behavior groups based on information collected that characterize actions taken by individuals in previous ones of the marketing campaigns.

20. The marketing campaign optimization system of claim 15 wherein processor-executable instructions or data which, when executed by the at least one processor, cause the at least one processor to:
identify target groups based on information collected that at least one of characterizes actions that represent an interest by individuals in a company that is a subject of the marketing campaign or characterizes a level of performance of a group of individuals in the marketing campaigns.

21. The marketing campaign optimization system of claim 20 wherein to identify target groups based on information collected that at least one of characterizes actions that represent an interest by individuals in a company that is a subject of the marketing campaign the processor-executable instructions or data, when executed by the at least one processor, cause the at least one processor to:
for each defined action, create a respective sets of individuals who took the action; and
for each of the defined actions, create a number of sub-groups of individuals who performed the action on a respective date.

22. The marketing campaign optimization system of claim 20 wherein to characterize a level of performance of a group of individuals in the marketing campaigns the processor-executable instructions or data, when executed by the at least one processor, cause the at least one processor to:
identify all audiences in respective ones of a plurality of the marketing campaigns;
identify at least one audience which includes a total number of individuals who has seen the respective marketing campaign that exceeds an average audience per marketing campaign; and
sort the number of actions according to an ordered list of actions.

23. The marketing campaign optimization system of claim 22 wherein to sort the number of actions according to an ordered list of actions the at least one processor sorts based on the following ordered list of actions:
a number of views of advertisements that are part of the respective marketing campaign, a number of selections of advertisements that are part of the respective marketing campaign, a number of signups for a company that is a subject of the respective marketing campaign, a number of requests for a demonstration of a product or a service that is a subject of the respective marketing campaign, a number of trials of a product or a service that is a subject of the respective marketing campaign, a number of initial payments generated by the respective marketing campaign, and a number of subsequent payments generated by the respective marketing campaign.

24. The marketing campaign optimization system of claim 15 wherein to train an artificial intelligence system with the campaign data the at least one of processor-executable instructions or data, when executed by the at least one processor, cause the at least one processor to train the artificial intelligence system with campaign data that includes at least one of: age, gender, political affiliation, industry, income, net worth, home type, home ownership, ethnic affinity, generation, household composition, family status, office status, educational status, school, years of post-secondary education, education major, employer, job title, device on which marketing campaign was experienced, operating system of device on which marketing campaign was experienced, connections, affinity group, personal behavior, or behavior within a product.

25. The marketing campaign optimization system of claim 15 wherein to train an artificial intelligence system with the performance data the at least one of processor-executable instructions or data, when executed by the at least one processor, cause the at least one processor to train the artificial intelligence system with performance data that includes at least one of: a number of impressions, a number of opens, a number of clicks, a number of views, a number of video views, a number of reactions, a number of shares, a number of comments, or a number of replies.

26. The marketing campaign optimization system of claim 15 wherein processor-executable instructions or data which, when executed by the at least one processor, cause the at least one processor to:
autonomously place creative of at one of the marketing campaigns into at least one of a broadcast distribution system, a multicast distribution system, or a unicast distribution system.
